(19) United States
(12) Patent Application Publication
(10) Pub. No.: US 2023/0105874 A1
(43) Pub. Date: Apr. 6, 2023

(54) WEAKLY COUPLED ABSORBER TO PLASMONIC DEVICE

(71) Applicant: The Government of the United of America, as represented by the Secretary of the Navy, Arlington, VA (US)

(72) Inventors: Heath Gemar, Washington, DC (US); Michael K. Yetzbacher, Burke, VA (US)

(21) Appl. No.: 17/935,083

(22) Filed: Sep. 23, 2022

Related U.S. Application Data
(60) Provisional application No. 63/261,598, filed on Sep. 24, 2021.

(51) Int. Cl. G01N 21/552

(52) U.S. Cl. CPC G01N 21/554

(57) ABSTRACT

A technique is provided for weakly coupling an absorber to a plasmonic device by placing an isolation layer in between them. This technique enables the spectral selective nature of a plasmonic device to be used in conjunction with an absorber. This technique optimizes the trade-off of near-field coupling and spectral selectivity to allow for deep sub-pixel examination of a scene, and is thus suited for multispectral imagers, among other applications.

### CROSS-REFERENCE TO RELATED APPLICATIONS

This application is a non-provisional of and claims the benefit of U.S. provisional application No. 63/261,598, filed on Sep. 24, 2021, the entirety of which is incorporated herein by reference.

### FEDERALLY-SPONSORED RESEARCH AND DEVELOPMENT

The United States Government has ownership rights in this invention. Licensing inquiries may be directed to Office of Technology Transfer, U.S. Naval Research Laboratory, Code 1004, Washington, D.C. 20375, USA; +1.202.767.7230; techtran@nrl.navy.mil, referencing Navy Case No. 210806-US2.

### STATEMENT REGARDING PRIOR DISCLOSURES BY THE INVENTOR(S)

A prior disclosure, “Near-field coupling of absorbing material to subwavelength cavities,” in Optical Materials Express, Volume 11, Issue 8, 1 Aug. 2021, was made by one or more of the inventors with other named authors. Those other authors who are not named as inventors of this patent application were working under the direction and supervision of at least one of the inventors.

### BACKGROUND

There have been countless efforts to make optical systems smaller. The discovery of extraordinary optical transmission (EOT) took a leap in this direction with the discovery of the ability to transmit light through deep subwavelength hole arrays in metals. EOT is a phenomenon of greatly enhanced transmission of light through the hole arrays. The main mechanisms contributing to this phenomenon are plasmons and Fabry-Perot resonances. Plasmons arise from the excitation of conduction electrons in a metal for frequencies less than the plasma frequency, which allows a modality for light to couple and propagate along a metallic surface. Fabry-Perot has been attributed to these structures because the resulting transmission, which given certain assumptions, comes out in the functional form of a Fabry-Perot equation. The Fabry-Perot resonances are typically described as general local resonances due to a fano-like resonance contribution in the spectra causing an asymmetric lineshape. Overall, the nano-apertures provide field enhancement both locally and globally, allowing for larger than classically expected transmission of light, and the ability to be highly selective (i.e., small bandwidth). Because of the selectivity and enhancement capabilities, this phenomena shows promise for a number of applications.

There have been numerous methodologies used to study the phenomena of EOT, including waveguide theory, antenna theory, Green's functions, and finite difference simulations. With waveguide theory, it has been found that the resonant wavelength can be associated to the long part of a rectangular waveguide due to mode confinement. However, the strength of the enhancement in the cavity is due to the short side of the rectangular waveguide due to the coupling of the evanescent fields from the inside surfaces. Analytical solutions for subwavelength apertures have been found utilizing fictitious currents. However, this theory requires a large depth of a cylindrical hole, thus reduces to the waveguide solution. Experimentally, EOT utilizing plasmonic effects have been shown through waveguides in one-dimensional slit guides or two-dimensional slot guides. Antenna theory provides a methodology of studying the Fabry-Perot like resonance associated with these small metallic structure by examining the resonances associated with small metallic rods or nanowire. They show how the finite extent of metals contributed to field distributions on the surfaces that may be applicable to cavities within a metal. To simplify models in search of an analytical solution, a common approach is to consider the metal to be a perfect electric conductor (PEC). This relegates the theory to the microwave or terahertz (THz) regime. While these models may be used qualitatively, they fail to capture the spectral features in the visible and infrared regimes accurately. Within the applicable THz regime, there are other possibilities that more fully capture the spectral features for both isolated and arrays of cavities. In addition, the above methods do not provide the ability to predict changes in spectral features due to changing depth of the subwavelength apertures, nor do they provide the ability to predict the shape of the resonance, which may be useful information for a variety of applications.

While there is research that examines cavities in a vacuum environment, there is also research that explores the effects of changing the dielectric environments. These investigations have included dependency of substrate material and cavity structures, and are closely related to metal-insulator-metal interfaces and environmental monitoring in biotechnology. There has been theoretical development made by determining Green's function with an arbitrary dielectric environment while modeling the metal as a perfect electric conductor. Many other studies of resonant nano-cavities have been done within the PEC approximation. While valid in the terahertz regimes, this approximation breaks down for other wavelength bands important for sensing and imaging technologies. The atmospheric transmission window from 3-5 microns (μm), commonly designated mid-wave infrared, is important for various applications, including defense, firefighting, and semiconductor wafer inspection. Previous studies have suggested that resonant nano-cavities may be useful for the demonstration of more efficient multispectral detectors. Coupling to an absorbing material may be essential for nano-cavities to be used as high efficiency spectrally selective optical devices. However, coupling a nano-cavity to an absorber destroys spectral selectivity, and thus remains a challenging task that has yet to be demonstrated.

### SUMMARY

A multispectral sensing technique is provided herein. The technique includes a multispectral sensor that has a plurality of spectral sensing devices. Each device having a plasmonic device layer coupled to an absorbing layer, with an isolation layer in between them to control the coupling strength and maintain desirable cavity properties. A method of fabricating the device is also provided.

A spectral sensing device is described herein. The device includes an absorbing layer configured to detect light and a plasmonic device layer comprising a first cavity configured to cause a resonance to occur from coupling plasmon waves into the first cavity. The device further includes an isolation layer formed between the absorbing layer and the plasmonic device layer, the isolation layer being configured to be changed to control coupling between the plasmonic device layer and the absorbing layer.

A method of fabricating a spectral sensing device that includes forming an absorbing layer configured to detect light. The method also includes forming an isolation layer adjacent to the absorbing layer, the isolation layer is configured to control coupling between the absorbing layer and a plasmonic device layer. The method further includes forming the plasmonic device layer adjacent to the isolation layer, the plasmonic device layer comprising a first cavity configured to cause a resonance to occur from coupling plasmon waves into the first cavity.

A multispectral sensor is described herein. The sensor comprises a first spectral sensing device that includes a first absorbing layer configured to detect light, a first plasmonic device layer comprising a first cavity configured to cause a resonance to occur from coupling plasmon waves into the first cavity, the first cavity having a first resonance wavelength, and a first isolation layer formed between the first absorbing layer and the first plasmonic device layer, the first isolation layer being configured to control coupling between the first plasmonic device layer and the first absorbing layer. The sensor further comprises a second spectral sensing device that includes a second absorbing layer configured to detect light, a second plasmonic device layer comprising a second cavity configured to cause a resonance to occur from coupling plasmon waves into the second cavity, the second cavity having a second resonance wavelength, and a second isolation layer formed between the absorbing layer and the second plasmonic device layer, the second isolation layer being configured to control coupling between the second plasmonic device layer and the second absorbing layer.

Further features and advantages of the invention, as well as the structure and operation of various embodiments are described in detail below with reference to the accompanying drawings.

### BRIEF DESCRIPTION OF THE DRAWINGS

FIGS. 1A-3B depict an overview of plasmonic apertures.

FIGS. 4A-6B depict an overview of cavity coupling and its effect on the spatial mode resonant within the cavity.

FIG. 7 is a plot depicting quantum efficiency as a function of isolation layer thickness.

FIG. 8A depicts a three-dimensional view of a spectral sensing device, according to an example embodiment.

FIG. 8B depicts a top view of the spectral sensing device of FIG. 8A.

FIG. 8C depicts an array of subwavelength cavities, according to an example embodiment.

FIG. 8D depicts a cross-sectional view of the spectral sensing device of FIG. 8A.

FIG. 9 depicts a schematic diagram of a multispectral sensor, according to an example embodiment.

FIG. 10 depicts a flowchart of a method for fabricating a spectral detecting device, according to an example embodiment.

### DETAILED DESCRIPTION

### Definitions

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, it is submitted that it is within the knowledge of one skilled in the art to effect such feature, structure, or characteristic in connection with other embodiments whether or not explicitly described.

In describing and claiming the disclosed embodiments, the following terminology will be used in accordance with the definition set forth below.

As used herein, the singular forms “a,” “an,” “the,” and “said” do not preclude plural referents, unless the content clearly dictates otherwise.

As used herein, the term “and/or” includes any and all combinations of one or more of the associated listed items.

As used herein, the term “about” or “approximately” when used in conjunction with a stated numerical value or range denotes somewhat more or somewhat less than the stated value or range, to within a range of ±10% of that stated.

Terminology used herein should not be construed as being “means-plus-function” language unless the term “means” is expressly used in association therewith.

### OVERVIEW

Multispectral imaging provides image data within specific wavelengths across the electromagnetic spectrum. Such wavelengths may be separated by filters or detected with the use of instruments that are sensitive to particular wavelengths, including infrared, visible light, and ultraviolet. Thus, multispectral imaging allows more information to be gathered than is detectable by the human eye with its limited receptors for red, green and blue visible range. However, typical image sensors detect light intensity with little or no wavelength specificity, thus color information may not be determined. A color image includes intensity information detected for different colors (e.g., red, green, blue) at the focal plane array. There are a variety of techniques currently used for color imaging, such as color filters (e.g., absorptive or dielectric), multi-camera systems with each camera being sensitive to one wavelength, dispersive devices (e.g., gratings, prisms, etc.), filter wheels, or nanoscale filters and sorters for the visible spectrum. Each of these techniques suffers from limitations, such as limited imaging rate, limited range (e.g., centimeter range or above), poor efficiency, bulky systems, costly to implement, or alignment issues among system components.

The technique described herein results from continued investigation of subwavelength systems by exploration of a varied dielectric environment in terms of an absorber. For applications that depend on conversion of optical energy to an electrical signal, as in solar cells or photodetectors, an absorber is necessary. Understanding the potential for near-field coupling of resonant nano-cavities allows for greater efficiency in the optical to electrical conversion and improve device performance. In particular, multispectral imaging detectors may achieve greater efficiency via sub-wavelength localized absorption rather than pixel-scale optical filtering (e.g., Bayer filter). Thus, the optical performance of nano-cavities in the presence of an absorber with varying dielectric environment serves as a foundation for the integration of resonant nano-cavities into sensors or photovoltaics.

This technique involves weakly coupling an absorber to a plasmonic device to implement a subwavelength multispectral detector for multispectral sensing. An isolation layer (e.g., a dielectric spacer) is utilized to control the coupling strength and maintain desirable cavity properties. This technique provides high efficiency, diffraction limited multispectral imaging at a reduced size, weight and cost compared to traditional imaging systems. The multispectral sensor may be used for signals incident on both isolated and arrays of metallic subwavelength cavities that propagate signals through near-field effects. This applies to passive or active broadband signals. The advantage to this technique is how it optimizes the trade-off of near-field coupling and spectral selectivity. In an example embodiment, the multispectral sensor may be used for multispectral imagers because it allows for deep sub-pixel examination of a scene. This technique is also broadly applicable to subwavelength near-field devices that may require absorber coupling.

### EXAMPLE EMBODIMENTS

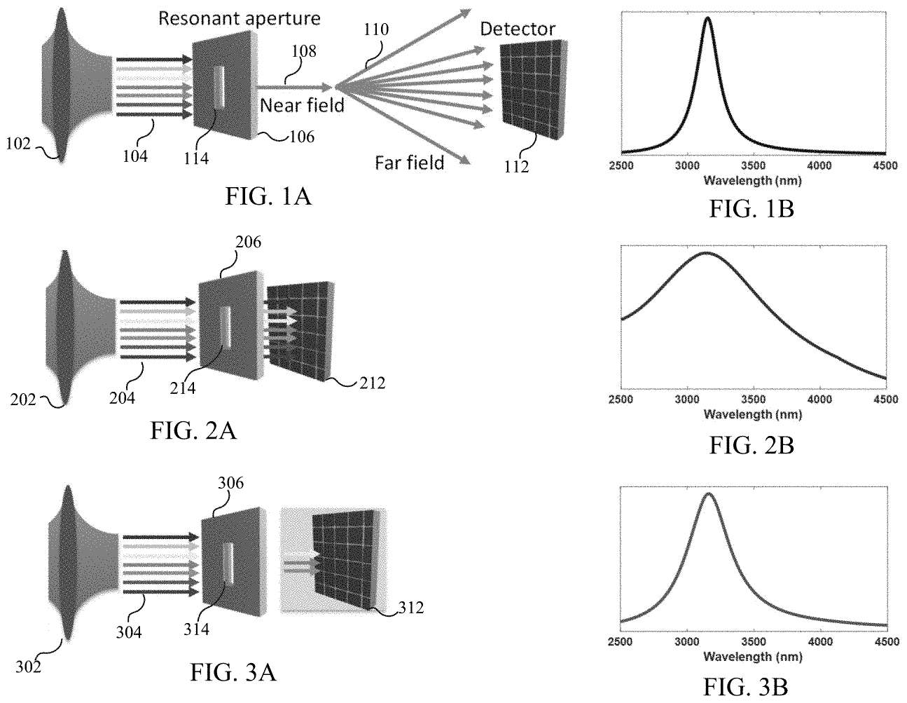

FIGS. 1A-3B depict an overview of plasmonic apertures. FIG. 1A depicts an imaging lens 102 configured to direct a cone of light 104 toward a metal screen 106. For example, light 104 may be visible light that is a combination of different colors ranging from red to violet, each having a different wavelength. The interactions between matter and different wavelengths of light give rise to colors in objects, specifically absorption, transmission and reflection. The color of an object indicates the wavelength that is reflected while the remaining wavelengths are absorbed. As light 104 is directed towards a metal screen 106, it interacts with metal screen 106, including resonant aperture 114. The geometry of aperture 114 affects how light 104 interacts with it and thus determines which wavelength is transmitted or reflected. Thus, in this example, only green light 108 has a frequency that matches the resonance frequency of aperture 114 and is thus transmitted. In other words, the size and shape of aperture 114 allows green light to resonate without decaying in aperture 114. The other colors having other wavelengths are reflected. Once green light 108 is transmitted from the near field to the far field, it separates and may be detected by image detector or absorber 112. Thus, when light 104 is allowed to propagate and detected at the far field, spatial resolution is lost, as the light spreads in the far field, destroying information regarding location of the aperture through which it was transmitted.

FIG. 1B depicts a plot showing the spectrum of transmission of aperture 114, shown in FIG. 1A. As shown in FIG. 1B, the transmission spectrum is a narrow one with only wavelengths of approximately 2900 nm to 3400 nm being transmitted for this aperture.

FIG. 2A is similar to FIG. 1A, depicting a lens 202 configured to direct a cone of light 204 being transmitted onto metal screen 206 with resonant aperture 214. Light 204 may bounce and back forth in aperture 214 before it is detected by absorber 212. In FIG. 2A, absorber 212 is depicted as being closer to metal screen 214, in the near field rather than the far field. In this case, because aperture 214 and absorber 212 are directly or so closely coupled, the properties of aperture 214 is changed due to the coupling, and wavelengths of all of the colors may be transmitted and detected. Plasmonic apertures are known to be spectrally selective, but this has not been practically demonstrated in any system using near-field detection. This is because when absorber 212 is placed closer to metal screen 214 as shown in FIG. 2A, the coupling between the two actually destroys resonance.

FIG. 2B depicts a plot showing the spectrum of transmission of aperture 214, shown in FIG. 2A. As shown in FIG. 2B, the transmission spectrum is a broad one, broader than that of aperture 114 shown in FIG. 1A. Direct detection of the cavity field via placement of absorber 212 in the vicinity of aperture 214 necessarily introduces loss, which broadens the spectral response. This is because every wavelength can resonate for a short period of time within aperture 214, and thus all the wavelengths may be sensed by the directly coupled absorber 212. However, while all colors are transmitted, there is no spectral differentiation because all the pixels of absorber 212 sense all the colors.

FIG. 3A depicts an imaging lens 302 configured to direct a cone of light 304 being transmitted onto metal screen 306 with resonant aperture 314 and is detected by absorber 312. In this case, careful control of the placement of absorber 312 allows resonance to survive as well as selective transmission. Here, one pixel may be distinguished from the next because light 304 does not spread as light 104 does in FIG. 1A as it is still detected in the near-field.

FIG. 3B depicts a plot showing the spectrum of transmission of aperture 314, shown in FIG. 3A. By controlling where the detector is positioned relative to aperture 314, the transmission spectrum of aperture 314 may be made narrower, to only transmit green and nearby wavelengths (e.g., between 2800 nm to 3600 nm) and reflect the remaining wavelengths.

The spectral response depends on geometric properties of the resonant cavity as well as the coupling between the plasmonic aperture and the absorber. Thus, it is possible to design the slit or cavity parameters in rectangular thin-slit geometry for desired spectra, including spectral shape as well as the resonance center wavelength and bandwidth. While example embodiments are focused on a particular spectral region with free space wavelengths between 2.5 and 6 microns, corresponding to the mid-wave infrared (MWIR), the technique described herein is not so limited. This technique may be used for other wavelength spaces, for example, visible, near infrared, and terahertz, in a multitude of applications, by changing the materials used and/or system parameters.

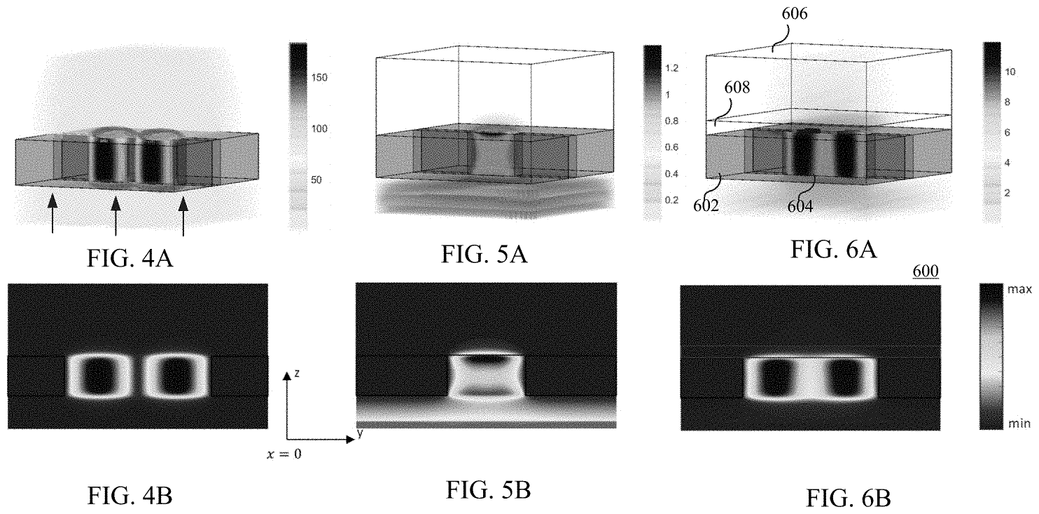

Optical cavities are important to the field of optics and photonics. They provide a mechanism in which a field can resonate and in turn produce a wonderful plethora of properties such as spectral selectivity, field enhancement, folded propagation lengths, and many more. The optical performance of nano-cavities in the presence of an absorber with varying dielectric environment is described below in reference to FIGS. 4A-6B, which depict an overview of cavity coupling.

FIGS. 4A-6B depict an overview of cavity coupling and its effect on the spatial mode resonant within the cavity. FIG. 4A shows a cavity directly coupled only to vacuum (DCV). That is, the cavity shown in FIG. 4A is not coupled to an absorber. Specifically, FIG. 4A shows an aperture in a silver material that forms a resonant optical cavity with light being propagated in the direction of the arrows from the bottom of the silver material. An important property of a resonant cavity is the quality factor or Q, which represents the ratio of energy stored in the cavity to the rate at which energy is dissipated from the cavity

$$( i . e . , Q = \frac{{v}_{0}}{Δ {V}_{FWHM}} ,$$

where ΔV_{FWHM} is the bandwidth or full width half maximum (FWHM) associated around each resonant frequency and v₀ is the center frequency of the resonant peak under consideration). Thus, the linewidth of a resonance is broader if the loss from the cavity at that wavelength is small. A high Q cavity is great at storing a large amount of energy with little loss. Another important quantity is the near-field power enhancement, T_{E}, similar to the normalized transmission, it describes the amount of power in a plane of the simulation volume normalized by the power of the illumination source, P₀

$$( i . e . , {T}_{E} ( z ; ω ) = \frac{{\sum }_{x , y} \vert S ( x , y ; z , ω ) \vert}{{P}_{0} ( z , ω )} ) .$$

To compare the different systems, a photon lifetime of

$${τ}_{p} = \frac{1}{Δω}$$

is used, where Δω is the FWHM of the resonance. The DCV cavity shown in FIG. 4A has Q=14.71 and τₚ=24.61 fs. FIG. 4B shows a cross-section in the y-z plane for the cavity shown in FIG. 4A at x=0 of the field distribution. As can be seen in FIG. 4B, the DCV cavity is an isolated cavity with strong resonance.

FIG. 5A shows a cavity directly coupled to an absorber (DCA). When the absorber is placed directly at the output plane of the aperture, this strongly couples the absorber material to the cavity and changes the effective index within the aperture. This has the undesirable effect of lowering the photon lifetime and broadening the resonance. For the DCA cavity, Q=1.97 and τₚ=3.3 fs. FIG. 5B shows a cross-section in the y-z plane for the cavity shown in FIG. 5A at x=0 of the field distribution. As can be seen in FIG. 5B, the power within the DCA cavity is much smaller than in the DCV cavity (shown in FIG. 4A) due to the loss within the cavity. The spectral selection capability of the DCV cavity is nearly completely undone by direct coupling to an absorber. In an experiment, directly coupling an absorber to the output of a cavity greatly diminishes the quality factor by nearly 85%, caused by a greater rate of dissipation of energy from the slit.

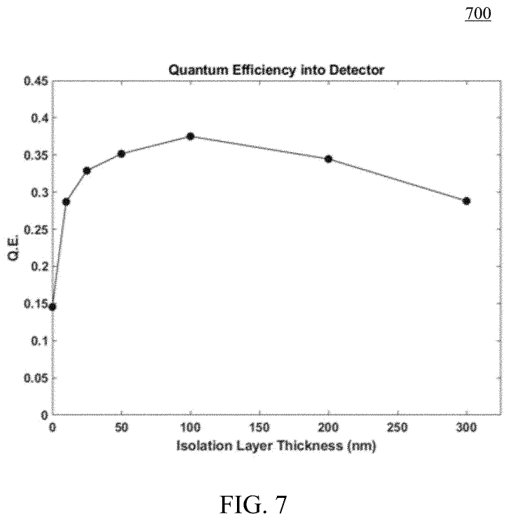

FIG. 6A shows a cavity weakly coupled to an absorber (WCA). One method of coupling to an absorber 606 while maintain a measure of isolation for the resonance of a cavity 604 in a metal layer 602 is to add an isolation layer (e.g., a dielectric such as silicon dioxide (SiO₂) 608 in between cavity 604 and absorber 606. The metal layer may also be referred to as the plasmonic device layer. Isolation layer 608 makes cavity 604 less leaky by effectively closing a “valve” to absorber 606. This works by decreasing the spatial overlap with the field resonating in cavity 604 and absorber 606, reducing the influence of the imaginary part of the complex refractive index of absorber 606 on the effective complex refractive index within cavity 604. This valve may be varied by changing the thickness of isolation layer 608, for example, between 10 and 800 nm, as shown in FIG. 7

FIG. 6B shows a cross-section in the y-z plane for the cavity shown in FIG. 6A at x=0 of the field distribution. As can be seen in FIG. 6B, the detection of cavity field is provided while resonance is maintained through controlled coupling. The WCA cavity with an isolation layer returns to similar spatial characteristics as the DCV cavity shown in FIG. 4B.

As an example, for a WCA system with a 100 nm isolation layer thickness, Q₁₀₀=3.72 gives a measure of the quantitative decoupling from the absorber. Comparing this case to the directly coupled absorber, a Q enhancement of 46% is found over the DCA case and the photon lifetime for the same WCA₁₀₀ system increases to 6.3 fs. It is not generally possible to detect a strongly enhanced field due to the perturbation of the enhancement by the detection event. However, the weakly coupled absorber, through the use of an isolation layer, allows for partial restoration of the quality of a resonant cavity, while still detecting the spectrally filtered and enhanced field within the slit. Thus, the isolation layer thickness provides a convenient way to control a trade-off between cavity quality and coupling into the detector.

FIG. 7 is a plot depicting quantum efficiency as a function of isolation layer thickness for a device having a cavity in a silver layer coupled to a gallium antimonide absorbing layer with an isolation layer of silicon dioxide in between them. Quantum efficiency (Q.E.) is the ratio of the amount of light incident on the device to the amount of light sensed by the device at a particular wavelength. In an example embodiment, a thick absorber layer is assumed, and therefore the quantum efficiency of the cavity system may be approximated as the transmission efficiency into the first layer of the absorber. This represents power flow into the absorber as shown in plot 700 of FIG. 7. In plot 700, a maximum Q.E. occurs at an isolation layer depth of 100 nm with a Q.E.=0.375. The Q.E. decrease at large isolation layer thickness is due to the limited extent of the resonance-enhanced field. A larger photon lifetime indicates a strong field enhancement, but due to the localized nature of these fields, their detection may not be efficiently accomplished with high cavity quality. Here, the Q.E. of coupling the optical fields into the absorbing material is accounted for, but not for the entire device (e.g., semiconductor doping and structure, other operational variables, etc.)

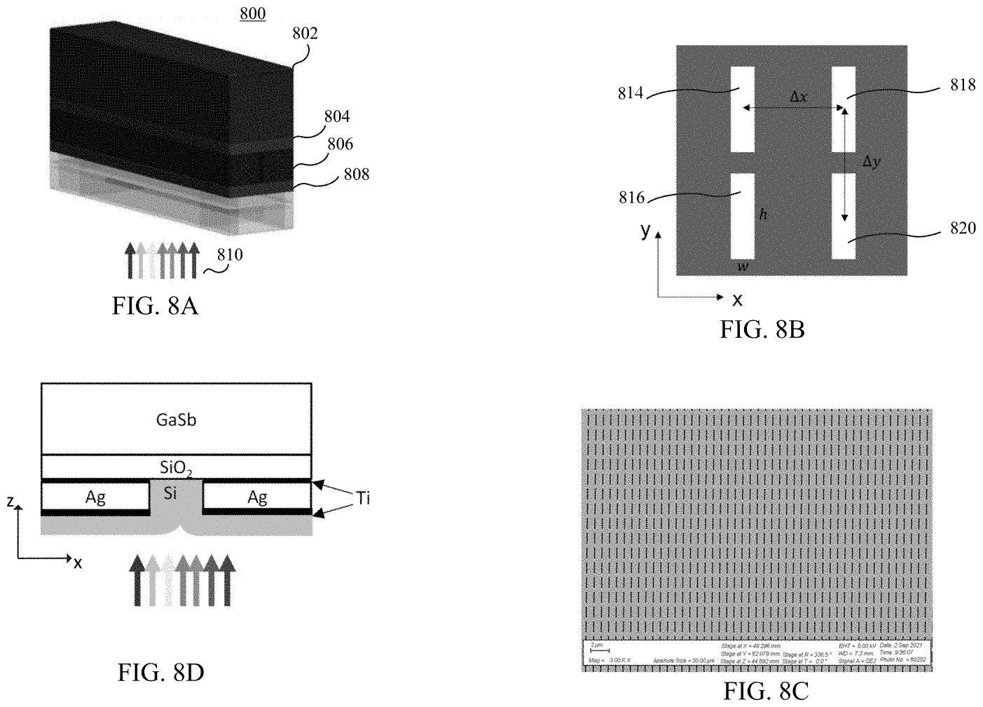

There are many ways to utilize the weak coupling between an absorber and a plasmonic device. For example, FIG. 8A depicts a three-dimensional view of a spectral sensing device, according to an example embodiment. FIG. 8 shows a device 800 that includes an absorbing layer 802, an isolation layer 804, a plasmonic device layer 806, an optional front layer 808. Absorbing layer 802 is configured to detect light 810 that propagates through the different layers before being detected by absorbing layer 802. Isolation layer 804 may be formed between absorbing layer 802 and plasmonic device layer 806. Isolation layer 804 may be designed to control coupling between plasmonic device layer 806 and absorbing layer 802. For example, the material(s) selected for isolation layer 804 and/or the thickness chosen for isolation layer 804 may affect the coupling, and the quantum efficiency as a result, as shown in FIG. 7. In embodiments, more, fewer or different layers may be included in device 800, depending on the application.

Another method to optionally enhance the resonant cavity further involves the dielectric environment on the front side of the aperture or cavity within plasmonic device layer 806. This may be accomplished by optionally adding front layer 808. This approximately has an effect on cavity quality without deteriorating the coupling to the absorber. In an example embodiment, device 800 is simulated with front layer 808 being implemented with 100 nm silicon dioxide with isolation layer 804 of 100 nm. The y-dimension of the cavity within plasmonic device layer 806 is 1010 nm. In this embodiment, the quality factor is calculated as being 4.22, which is a 20% enhancement over the system without a front layer. In addition to the increased quality factor, this embodiment also has an increased quantum efficiency of 0.402 and a photon lifetime of 7.13 fs. Thus, front layer 808 is designed to improve the resonance or the quality factor of the cavity adjacent to it.

FIG. 8B depicts a top view of the spectral sensing device of FIG. 8A. In FIG. 8B, plasmonic device layer 806 (shown in FIG. 8A) is shown as including one or more subwavelength resonant cavities 814, 816, 818, and 820, each of which is designed to cause a resonance to occur from coupling plasmon waves into itself. In an embodiment, each of the cavities 814-820 may have identical x, y, and z dimensions of 100 nm, 120 nm, and 100 nm, respectively. In another embodiment, the dimensions of each cavity may be different from one another, creating a multispectral device when each cavity is weakly coupled to an independent detector. In general, the dimensions of cavities 814-820 may be a fraction of the wavelength of light, (e.g., 50-700 nm for MWIR light). The cavity spacing extends 800 nm in the x direction (Δx) and 1600 nm in the y direction (Δy). In an embodiment, the spacing may be controlled to augment the spatial sampling of the spectral sensing device. That is, the cavity spacing has an effect on spectral resolution. In addition, changing a dimension of a cavity (e.g., width, height, or depth) may result in spectral response changes.

The table below shows the spectral features resonant wavelength as a blue or red shift and the bandwidth as increasing or decreasing to corresponding geometric changes.

TABLE 1
Effect of changing geometric parameters of subwavelength cavities

| Spectral Property | Δw > 0 | Δw < 0 | Δh > 0 | Δh < 0 | Δd > 0 | Δd < 0 |
|---|---|---|---|---|---|---|
| λᵣ | Blue | Red | Red | Blue | Blue | Red |
| σ | Increase | Decrease | Increase | Decrease | Decrease | Increase |

FIG. 8C depicts an array of subwavelength cavities, according to an example embodiment. In an example embodiment, the subwavelength resonant cavities 814-820 (shown in FIG. 8B) may be implemented as a fabricated array of subwavelength cavities (e.g., 1250 and 625 cavities in the x and y directions, respectively), as shown in FIG. 8C, each of which may have the same size and shape, although this is not required.

FIG. 8D depicts a cross-sectional view of spectral sensing device 800 of FIG. 8A. In an example embodiment, device 800 may be implemented with gallium antimonide (GaSb) as absorbing layer 802, silicon dioxide (SiO₂, e.g., 100-270 nm) or any reasonably transparent material as isolation layer 804, silver (Ag, e.g., 90-100 nm) as plasmonic device layer 806, and silicon dioxide as front layer 808. In addition, plasmonic device layer 806 may be covered on top and bottom with a thin titanium (Ti) layer (e.g., 5 nm) to improve adhesion and to avoid oxidation. While silver is shown in FIG. 8D as the plasmonic device layer, any other reflective metal may be used to form the plasmonic device layer in example embodiments. In addition, a fill material (e.g., silicon, silicon dioxide, or silicon nitride) may be used to fill one or more subwavelength cavities as shown in FIG. 8D. The fill material is designed to have an impact on the effective index of refraction within the cavity, and thus it may be used to further control the coupling between the plasmonic device layer and the absorbing layer. The fill material may also form the front layer (e.g., front layer 808 shown in FIG. 8A). In an example embodiment, the isolation layer, the fill material and the front layer may be formed of the same material, and in other example embodiments they may be formed of different materials or different combinations of materials.

In addition to geometric changes, the material with which the subwavelength cavity is constructed may also change the spectrum. For example, for the same dimensions, a narrowing of the bandwidth may occur while varying the material from aluminum (Al) to silver (Ag) to gold (Au). The variation in resonance wavelength corresponds to the imaginary part of the index of refraction (k) of the material. Traditional approximations negate the absorption of the metals, which is related to the imaginary part of the index (k) of the material. Confinement of fields by the slit is strongly affected by the skin depth of the material, which is determined by k.

TABLE 2
A comparison of imaginary refractive index to
conductivity of different metals.

| Material | Al | Ag | Au |
|---|---|---|---|
| k | 35.61 | 24.14 | 23.35 |
| σ_{c} | 3.77 × 10⁷ | 6.30 × 10⁷ | 4.11 × 10⁷ |

The choice of materials and parameters such as layer thickness, cavity spacing and cavity geometry may be based on the application and is not limited to the examples described herein. In general, the coupling between the absorbing layer and the plasmonic device layer may be achieved by controlling the optical cavity environment. The refractive index of material inside the cavity may be controlled with a fill material. The material and extent of the isolation layer determine the resulting coupling. Thus, the isolation layer may be designed to control the coupling and may serve as an additional degree of freedom in spectral engineering. For example, the isolation layer may be designed (via selection of material(s) and thickness) to optimize for a range of wavelengths and resonance shapes to maximize the detection of light.

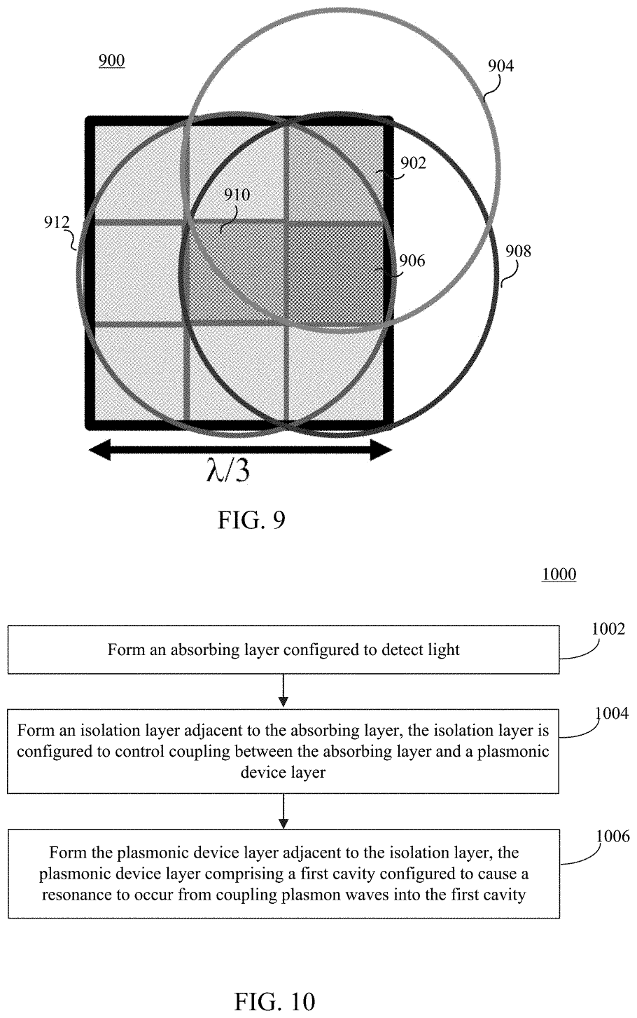

Spectral detecting device 800 shown in FIG. 8A may be implemented in various systems. For example, FIG. 9 depicts a schematic diagram of a multispectral sensor 900, according to an example embodiment. Sensor 900 includes a plurality of pixels, with nine being shown in FIG. 9. Each pixel corresponds to a detector or spectral sensing device (e.g., device 800 shown in FIG. 8A) that has a different resonance wavelength and is thus sensitive to a different wavelength or color of light. For example, pixel 902 corresponds to green light, pixel 906 corresponds to red light, and pixel 910 corresponds to blue light.

Sensor 900 has a dimension (e.g., length or width) that is a fraction of a wavelength of light (e.g., ˜1000 nm). Based on an experiment, the quality factor is found to change with variability in the subwavelength spacing of the cavities (Δx) showing an increase to a plateau at approximately λ/3 spacing. Q rises from 8 to 15, nearly twice the value from Δx of 400 to 800 nm. In addition, the quantum efficiency decreases linearly in a similar manner, correlating to a limit in the amount of photons absorbed by the system. The Δx maximizes photon absorption at approximately λ/3. After photon absorption hits a plateau of 600 photons (a.u.) the quantum efficiency changes in a linear manner associated to an increase in the domain size. Thus, subwavelength cavities resulting from similar systems have a spatial extent and funnel light incident on the surface from λ/3 away from the cavity center along the—dimension. Because of the funnel effect, the blue detecting device associated with pixel 910, has an optical reach 912 that is larger than its physical size. Similarly, the red detecting device associated with pixel 906 has an optical reach 908, and the green detecting device associated with pixel 902 has an optical reach 904. Accordingly, there is an overlap of optical reach among the detectors, and with them being so small in size, the efficiency of sensor 900 can come close to 100 percent. Sensor 900 is suitable for fast imaging, as light may be sensed as fast as an image may be taken. Sensor 900 is also low in size, weight, and power as there are no moving parts. Furthermore, the potential for low-cost volume production exists for sensor 900. Accordingly, sensor 900 provides high spectral contrast and high resolution, making it suitable for precision applications. It also has a wide angle of acceptance, diffraction-limited image resolution and can operate in the mid-wave infrared regime, as well as other regimes (e.g., long wave infrared or optical spectrum) by selection of the appropriate material(s) for the desired regime.

FIG. 10 depicts a flowchart of a method for fabricating a spectral sensing device, according to an example embodiment. For example, flowchart 1000, shown in FIG. 10, may be used to fabricate spectral sensing device 800 shown in FIG. 8A. Any suitable fabrication process(es) may be utilized to implement flowchart 1000. For example, e-beam lithography technique is capable of creating cavities with extent as small as 100 nm in material depths of 100 nm, and is suitable for fabricating this device. In embodiments, flowchart 1000 may include more or fewer steps and the steps may be performed in an order different than shown in FIG. 10.

In step 1002, an absorbing layer configured to detect light is formed. For example, absorbing layer 802 of FIG. 8A may be formed using gallium antimonide with a thickness that is suitable for the desired application.

In step 1004, an isolation layer is formed adjacent to the absorbing layer, the isolation layer is configured to control coupling between the absorbing layer and a plasmonic device layer. For example, isolation layer 804 of FIG. 8A may be formed using any reasonably transparent material, such as silicon, silicon dioxide, or silicon nitride with a thickness that is suitable for the desired application (e.g., 20-100 nm).

In step 1006, a plasmonic device layer is formed adjacent to the isolation layer. The plasmonic device layer comprises a first cavity configured to cause a resonance to occur from coupling plasmon waves into the first cavity. For example, plasmonic device layer 806 of FIG. 8A may be formed using any reflective metal, such as silver or gold with one or more cavities that maybe optionally filled with a fill material to impact an effective index of refraction within the cavities. The cavity may be a subwavelength cavity with dimensions that are a fraction of a wavelength of light (e.g., 400-700 nm). Another cavity may be formed adjacent to the first cavity with a spacing in between them. This spacing may be controlled to augment a spatial sampling of the spectral sensing device. The cavities may have the same or different geometries.

An optional front layer may be formed adjacent to the plasmonic device layer. For example, front layer 808 may be formed to improve the resonance within the cavities and/or a quality factor of the cavities.

In an example embodiment, the spectral sensing device may be fabricated starting with preformed wafers (e.g., Si) that may be cleaned, for example, with acetone and isopropyl alcohol and/or a plasma preen technique. To make cavities with a lower effective index, a layer of silicon dioxide (e.g., 100 nm thick) may be added as an isolation layer. One way to deposit this isolation layer is via plasma-enhanced chemical vapor deposition (PECVD), specifically Oxford PECVD. A negative resist may be spin coated (e.g., MA-n 2403 from micro resist technology) onto the isolation layer. The substrate spin rate may have a ramp of 500 Hz/s reaching 3000 Hz for 60 seconds. In order for the resist to spread evenly, viscous chemicals may be added to the resist to form a resist of approximately 300 nm in depth.

A CAD drawing and e-beam lithography file (e.g., KLayout, Beamer) of a two dimension cross section of the spectral sensing device may be used. A dose of 350 μC/cm² may be used to create features, for example, 100 nm in size. An important parameter for e-beam lithography is the dose that effectively dictates how many electrons are impacted per unit area. Too low a dosage may cause dropouts within the design due to too little of the resist becoming activated. Too high a dosage may activate more of the resist due to reflection of electrons from the bottom surface. This prevents the developer from dissolving portions of the resist meant to be taken off. The ideal dose causes a slight undercut at the bottom of the resist due to less activation as the electron beam passes through. The desired undercut allows for easier lift-off After a pattern is implemented from the e-beam, a developer (e.g., MD 525 for 60 seconds) may be needed to remove the portion of the resist that was not bombarded with electrons.

For metal deposition, a temescal e-beam evaporation may be used to evaporate the silver to a desired thickness (e.g., 100 nm). An additional 5 nm layer of titanium may be used on the top and bottom of the silver layer to help the silver adhere to the remaining layers as well as to protect the top layer from oxidation. A process known as lift-off may be used to dissolve the resist remaining on the substrate. Another solvent (e.g., PG remover) may be used to remove the resist because of the top layer of titanium, which provides protection for the silver layer. If PG remover is used on bare silver, the top surface may tarnish, thus destroying its useful properties. This step removes the top layer of silver on the resist, leaving cavities the size of the pattern written by the e-beam lithography tool.

### CONCLUSION

While various embodiments of the disclosed subject matter have been described above, it should be understood that they have been presented by way of example only, and not limitation. Various modifications and variations are possible without departing from the spirit and scope of the described embodiments. Accordingly, the breadth and scope of the disclosed subject matter should not be limited by any of the above-described exemplary embodiments.

What is claimed is:

1. A spectral sensing device, comprising:
an absorbing layer configured to detect light;
a plasmonic device layer comprising a first cavity configured to cause a resonance to occur from coupling plasmon waves into the first cavity; and
an isolation layer formed between the absorbing layer and the plasmonic device layer, the isolation layer being configured to control coupling between the plasmonic device layer and the absorbing layer.

2. The device of claim 1, wherein the plasmonic device layer comprises a metal.

3. The device of claim 1, wherein the first cavity is a subwavelength cavity that has dimensions that are a fraction of a wavelength of the light.

4. The device of claim 1, further comprising:
a fill material configured to fill the first cavity, thereby impacting an effective index of refraction within the first cavity.

5. The device of claim 1, further comprising:
a front layer configured to be adjacent to the plasmonic device layer, the front layer being configured to improve at least one of the resonance or a quality factor of the first cavity.

6. The device of claim 1, further comprising:
a second cavity on the plasmonic device layer that is adjacent to the first cavities; and
a spacing between the first cavity and the second cavity, the spacing being configured to be controlled to augment a spatial sampling of the device.

7. The device of claim 6, wherein the first cavity and the second cavity have different resonance wavelengths.

8. A method of fabricating a spectral sensing device, comprising:
forming an absorbing layer configured to detect light;
forming an isolation layer adjacent to the absorbing layer, the isolation layer is configured to control coupling between the absorbing layer and a plasmonic device layer; and
forming the plasmonic device layer adjacent to the isolation layer, the plasmonic device layer comprising a first cavity configured to cause a resonance to occur from coupling plasmon waves into the first cavity.

9. The method of claim 8, wherein forming the plasmonic device layer comprises forming the plasmonic device layer with a metal.

10. The method of claim 8, further comprising:
forming the first cavity as a subwavelength cavity that has dimensions that are a fraction of a wavelength of the light.

11. The method of claim 8, further comprising:
filling the first cavity with a fill material, thereby impacting an effective index of refraction within the first cavity.

12. The method of claim 8, further comprising:
forming a front layer configured to be adjacent to the plasmonic device layer, the front layer being configured to improve at least one of the resonance or a quality factor of the first cavity.

13. The method of claim 8, further comprising:
forming a second cavity on the plasmonic device layer that is adjacent to the first cavity; and
controlling a spacing between the first cavity and the second cavity to augment a spatial sampling of the device.

14. The method of claim 8, wherein the coupling between the plasmonic device layer and the absorbing layer is controlled via at least one of a selection of material or thickness of the isolation layer.

15. A multispectral sensor, comprising:
a first spectral sensing device comprising
a first plasmonic device layer comprising a first cavity configured to cause a resonance to occur from coupling plasmon waves into the first cavity, the first cavity having a first resonance wavelength, and
a first isolation layer formed between the first absorbing layer and the first plasmonic device layer, the first isolation layer being configured to control coupling between the first plasmonic device layer and the first absorbing layer; and
a second spectral sensing device comprising
a second absorbing layer configured to detect light,
a second plasmonic device layer comprising a second cavity configured to cause a resonance to occur from coupling plasmon waves into the second cavity, the second cavity having a second resonance wavelength, and
a second isolation layer formed between the second absorbing layer and the second plasmonic device layer, the second isolation layer being configured to control coupling between the second plasmonic device layer and the second absorbing layer.

16. The sensor of claim 15, wherein the first spectral sensing device and the second spectral sensing device each has a respective optical reach that is larger than its physical size.
